(19) United States
(12) Patent Application Publication
(10) Pub. No.: US 2012/0109995 A1
(43) Pub. Date: May 3, 2012

(54) ANTINULL USAGE AND SIMULATION IN DATA FILTERING

(75) Inventors: Christopher A. Hays, Monroe, WA (US); Aaron S. Meyers, Kirkland, WA (US); Alexandre I. Mineev, Kenmore, WA (US)

(73) Assignee: Microsoft Corporation, Redmond, WA (US)

(21) Appl. No.: 12/914,015

(22) Filed: Oct. 28, 2010

(51) Int. Cl. G06F 17/30

(52) U.S. Cl. 707/769; 707/E17.069

(57) ABSTRACT

Comparing data items. The method includes accessing a query or command to retrieve data. The query or command includes an identification of a data item, a logical operator and a specialized token. A comparison as defined by the logical operator between the data item and the specialized token is performed. The following illustrates the results of the logical operation on any data item and the specialized token: an equal logical operation results in true, a greater than logical operation results in false; a less than logical operation results in false; a greater than or equal to logical operation results in true; a less than or equal to logical operation results in true; a not equal logical operation results in false; an IN logical operation results in true; and a NOT IN logical operation results in false. As a result of the comparison, the data item may be retrieved.

### BACKGROUND

### Background and Relevant Art

Computers and computing systems have affected nearly every aspect of modern living. Computers are generally involved in work, recreation, healthcare, transportation, entertainment, household management, etc.

Within a data application, there is no simple general approach for efficient parameterized selection of data where sometimes a subset of data is selected while at other times all of the data is selected.

For example, consider the following SQL query:

SELECT Customer.Id, Customer.Name, Customer.Age
FROM Customer
WHERE Customer.Name IN (@CustomerNames)

Once parameter values have been passed in to this query, it may end up equivalent to the following:

SELECT Customer.Id, Customer.Name, Customer.Age
FROM Customer
WHERE Customer.Name IN (‘Maria’, ‘Abdul’, ‘John’)

But in the event the consumer of the data wants to actually see all of the customers, this approach can become quite unwieldy and slow to execute if there are a large number of customers. A far more efficient way to retrieve all customers would be to omit the filter condition entirely:

SELECT Customer.Id, Customer.Name, Customer.Age
FROM Customer

Unfortunately, this causes the structure of the query to change based on the parameter values, which is frequently not an option in data applications. What is needed is a way to pass in a parameter value which itself indicates that the filter condition should be omitted.

There are three typical solutions to this problem which are used in a variety of data applications. The first solution is wildcarding. For textual data, many data applications provide the ability for filter conditions to include wildcards for pattern matching. For example, an SQL query to find all customers whose name starts with “C” would be:

SELECT Customer.Id, Customer.Name, Customer.Age
FROM Customer
WHERE Customer.Name Like ‘C %’

Parameterized, it would look like this:

SELECT Customer.Id, Customer.Name, Customer.Age
FROM Customer
WHERE Customer.Name Like @CustomerName

This would allow a user to pass in ‘%’ as a parameter value, which would match every customer name. Unfortunately, this approach only works for textual data and typically does not allow for selection of multiple specific items (e.g. Maria, Abdul and John from the example above).

The second solution is custom code. In most cases, data applications use specific hand-coded solutions to achieve this result for each query. This generally take the form of custom code that switches between the filtered and unfiltered forms of the query. In the case of SQL databases, this logic is often built into a stored procedure used for data retrieval, overloading the meaning of “null” to indicate the query should be unfiltered.

For example:

```
IF (@CustID is null)
  SELECT Customer.CustomerID
  FROM Sales.Customer Customer
ELSE
  SELECT Customer.CustomerID
  FROM Sales.Customer Customer
  WHERE Customer.CustomerID = @CustID
```

The third solution is the [All] member in dimensional databases. There exists a related concept in dimensional databases: the [All] member. However, this value of a hierarchy represents the aggregate of all of the members of the hierarchy rather than a reference to the collection of all members in the hierarchy individually. For example, a query for sales for the [All] customer would result in a single grand total number rather than one number for each customer. As a result, similar techniques are still used as described above if either filtered or nonfiltered data may be desired based on a parameter value.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment includes a method for comparing data items. The method includes accessing a query or command to retrieve data. The query or command includes an identification of a data item, a logical operator and a specialized token. A comparison as defined by the logical operator between the data item and the specialized token is performed. The following illustrates the results of the logical operation on any data item and the specialized token: an equal logical operation results in true, a greater than logical operation results in true; a less than logical operation results in true; a greater than or equal to logical operation results in true; a less than or equal to logical operation results in true; a not equal logical operation results in false; an IN logical operation results in true; and a NOT IN logical operation results in false. As a result of the comparison, the data item may be retrieved. Other embodiments may include systems that include modules for operating on the specialized token in the manner described above.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a table showing results of logical operations on a specialized token;

FIG. 2 illustrates a topology including a front end user interface, an interface layer, and a backend data application;

FIG. 3A illustrates a graphical user interface;

FIG. 3B illustrates a graphical user interface;

FIG. 3C illustrates a graphical user interface;

FIG. 3D illustrates a graphical user interface;

FIG. 4 illustrates a flow for query construction; and

FIG. 5 illustrates a method of comparing data items.

### DETAILED DESCRIPTION

Embodiments may extend data systems to include a specialized token illustrated and described herein as “AntiNull”. The AntiNull token has custom semantics which define how it interacts with other values in the system, particularly in comparisons and computations. These semantics ensure the use of AntiNull as a parameter value for data filtering results in the data being unfiltered. In addition, embodiments may include declarative configuration for interoperability with systems which do not natively support AntiNull tokens.

AntiNull is a specialized token which represents all possible values in the domain where AntiNull is used. While not precisely the opposite of null (which represents either an unknown value or a value outside of the domain), AntiNull has many characteristics which are complementary to null behavior.

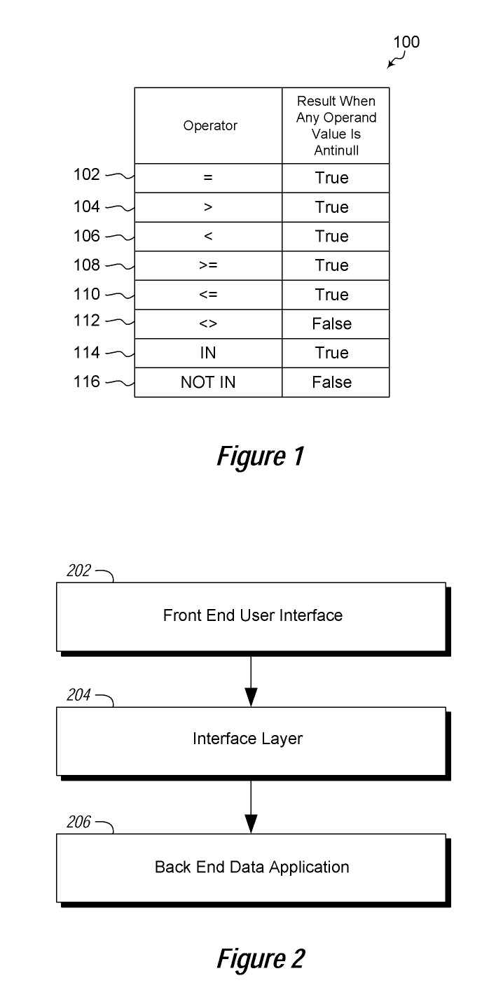

The following illustrates the behavior of AntiNull in filter conditions. For AntiNull to behave as a “do not apply this filter” indicator within filter conditions, there are specific semantics for how it interacts with other values in the system, particularly within comparison operators. Referring now to FIG. 1, a table 100 with logical comparison operators is illustrated. The table 100 summarizes the values which are returned from each of the common Boolean logical operators when AntiNull is one of the operands. At 102, table 100 illustrates that the equal comparison between any operand and AntiNull returns “True.” At 104, table 100 illustrates that the greater than comparison between any operand and AntiNull returns “True.” At 106, table 100 illustrates that the less than comparison between any operand and AntiNull returns “True.” At 108, table 100 illustrates that the greater than or equal to comparison between any operand and AntiNull returns “True.” At 110, table 100 illustrates that the less than or equal to comparison between any operand and AntiNull returns “True.” At 112, table 100 illustrates that the not equal comparison between any operand and AntiNull returns “False.” At 114, table 100 illustrates that the IN comparison between any operand and AntiNull returns “True.” The IN operator compares an item to a set of items. If the item is equal to any member of the set, the IN operator returns “True”, otherwise it returns “False”. At 116, table 100 illustrates that the NOT IN comparison between any operand and AntiNull returns “False.”

Unlike null, which uses three-state Boolean logic via the value “Unknown”, AntiNull does not introduce an additional truth state.

The following illustrates examples of the use of AntiNull.

Each of the following queries will return all customers:

SELECT Customer.Id, Customer.Name, Customer.Age
FROM Customer
WHERE Customer.Name = AntiNull
SELECT Customer.Id, Customer.Name, Customer.Age
FROM Customer
WHERE Customer.Age IN (AntiNull)

Each of the following queries will return no customers:

SELECT Customer.Id, Customer.Name, Customer.Age
FROM Customer
WHERE Customer.Age <> AntiNull
SELECT Customer.Id, Customer.Name, Customer.Age
FROM Customer
WHERE Customer.Name NOT IN (AntiNull)

The following illustrates the behavior of AntiNull in calculations.

In a first set of illustrations, the following illustrates the behavior of operations involving AntiNull for mathematical and string operators. Because AntiNull is not a data value, but a marker for all values in the domain, using mathematical operators on AntiNull results in all values in the domain, which is represented by AntiNull. Each of the following expressions will return AntiNull:

Customer.Age + AntiNull
AntiNull / 10
Customer.Name ∥ AntiNull
Left(AntiNull,3)

The following query returns products of a specified weight, in kilograms, where the database contains weights in grams:

SELECT Product.Id, Product.Name
FROM Product
WHERE Product.Weight = @Kilograms * 1000

When AntiNull is passed in as the value of the @Kilograms parameter to this query, the calculation (AntiNull*1000) results in AntiNull, which is then compared to Product.Weight. This will evaluate to True, resulting in all products being shown.

In a second set of illustrations of AntiNull behavior in calculations, the following illustrates the behavior of operations involving AntiNull for aggregate functions. Aggregate functions which operate over AntiNull return AntiNull.

For example, each of these expressions will return AntiNull:

Sum (AntiNull)
Count(AntiNull)
Max(AntiNull + 6)
Variance(Customer.Age/10)

The following illustrates the behavior of operations involving AntiNull for other operators and functions. While in general, all operators and functions which take AntiNull as an argument should return AntiNull, there exist exceptions. Specifically, functions which incorporate implicit comparisons take into account the comparison operator rules above. For example, consider a hypothetical function which conditionally returns one of two values based on a comparison: SwitchIfSame(FirstValueToCompare, SecondValueToCompare, ResultValueIfSame, ResultValueIfDifferent). In this case, the conditional logic in the function would dictate that SwitchIfSame should not always return AntiNull if one of the arguments is AntiNull. Instead, the logic of the function will explicitly take into account AntiNull comparison semantics. In this example, SwitchIfSame(Value1, AntiNull, <RetVal1>, RetVal2) will behave identically to SwitchIfSame(Value1,Value1,RetVal1,RetVal2)

The following illustrates user interface AntiNull value configurations. Existing front end user interfaces 202 (See FIG. 2) for data stores, such as data applications 206 may not natively contain the concept of AntiNull. When such a front end user interface 202 is used atop a back end data application 206 which does support AntiNull, a simple interface layer 204 is used to expose this to the user. There may be two parts to this interface layer 204. First, a standard value outside of the normal domain of values is defined to represent AntiNull. Secondly, this value may be optionally bound to an existing user interface element which represents unfiltered data.

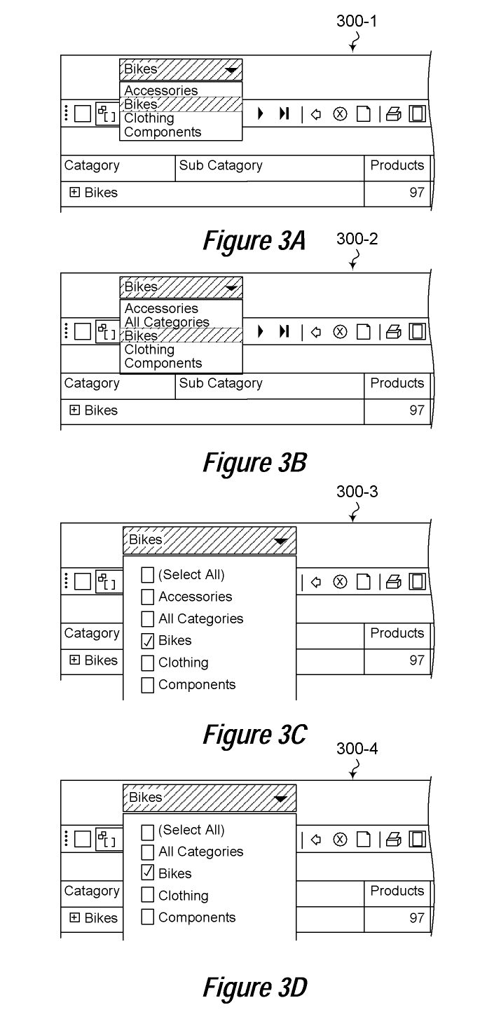

For example, a simple parameter value selection user interface might appear like the user interface 300-1 shown in FIG. 3A.

By configuring a standard value “All Categories” to represent AntiNull for this parameter, the user interface 300-2 would appear as shown in FIG. 3B. In this case, the front-end user interface 202 has no knowledge of the special semantics of “All Categories” which will be used by the back-end data application 206.

If, however, the front-end user interface 202 has a standard naïve implementation of “show everything” (which simply enumerates each value to pass to the back-end system), the user interface 300-3 may appear as shown in FIG. 3C.

The inserted “All Categories” is treated as a possible value just like any other, causing the user interface option of “(Select All)” to be redundant. In this case, additional configuration information is provided to bind the AntiNull token value to the built-in user interface “show everything” behavior, resulting in the user interface 300-4 shown in FIG. 3D. Configured in this way, the user interface will pass the value “All Categories” to the back-end data application when “(Select All)” is chosen. The back-end will then treat “All Categories” as AntiNull.

The following is one example representation of this configuration information:

```
<ReportParameter Name=“Category”>
  <DataType>String</DataType>
  <Prompt>Category</Prompt>
  <ValidValues>
    <DataSetReference>
      <DataSetName>Categories</DataSetName>
      <ValueField>Name</ValueField>
      <LabelField>Name</LabelField>
    </DataSetReference>
    <AntiNull>
      <Value>ALL</Value> <!-- Specifies the value to use as AntiNull -->
      <Label>All Categories</Label> <!-- Label unused if bound to Select
All -->
    </AntiNull>
  </ValidValues>
  <MultiValue>true</MultiValue>
  <SelectAllMode>AntiNull</SelectAllMode>
    <!-- AntiNull = Select All passes the AntiNull value -->
    <!-- Collection = Select All passes the full set of all values -->
    <!-- None = No Select All option to be provided to the user -->
</ReportParameter>
```

The following discussion now focuses on query interface AntiNull value configuration and behavior. Existing data applications do not natively contain the woo concept of AntiNull. When such a data application 206 is used as the back-end data provider to a system which does support AntiNull, an interface layer 204 may be used to rewrite the queries. Specifically, each of the rules illustrated in FIG. 1 and the behavior of AntiNull in calculations described above are implemented as generic query rewrite rules. For example, based on the rule for the equality operator, this query:

SELECT Customer.Id, Customer.Name, Customer.Age
FROM Customer
WHERE Customer.Name = AntiNull

would be rewritten as this query:

SELECT Customer.Id, Customer.Name, Customer.Age
FROM Customer
WHERE True

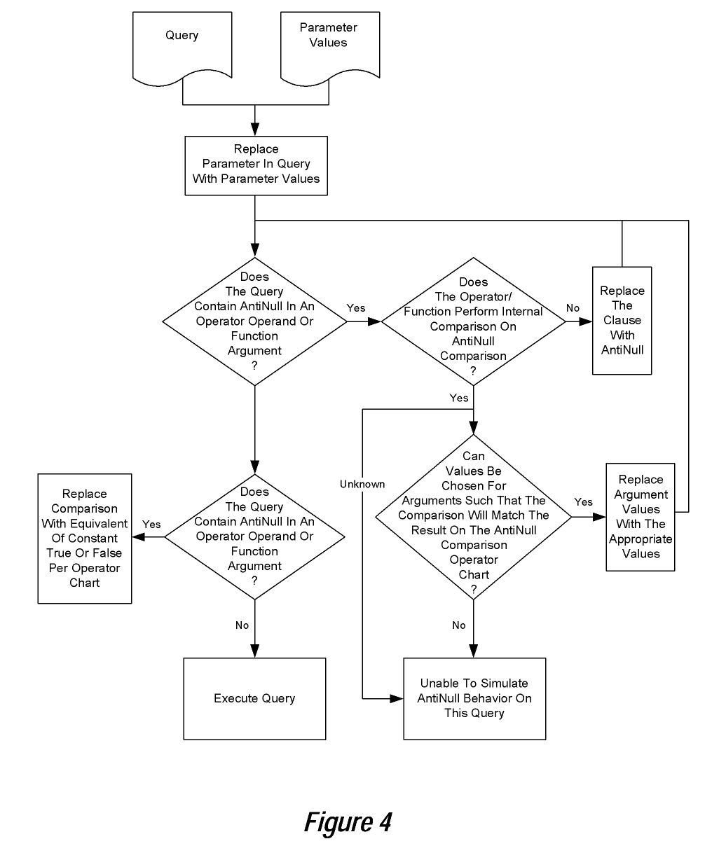

Thus a query including AntiNull can be rewritten to a query for use on an underlying data application 206 that does not support AntiNull. While the specific syntax used for the rewrite depends on the syntax of the filter and calculation language (e.g. in the example above, most SQL dialects would use “1=1” rather than “true”), the semantics of the rewrite rules may be consistent across back-end data applications 206. Referring now to FIG. 4, a query rewrite flowchart is illustrated that shows an algorithm for rewriting queries that may be used in some embodiments.

Note that for some data applications, filters may be applied automatically based on parameter values and therefore not appear explicitly in the query. For example, passing “Joe” as the value of the parameter [CustName] to this query would result in a list of customers named Joe.

SELECT Customer.Id, Customer.Name, Customer.Age
FROM Customer

The interface layer 204 to such a data application 206 would not need to rewrite the query to simulate the behavior of AntiNull. Instead, it would simply not provide a value for the parameter to the data application if the value is AntiNull.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

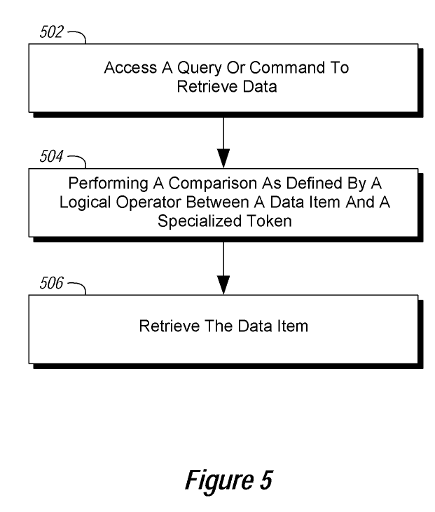

Referring now to FIG. 5, a method 500 is illustrated. The method 500 may be practiced in a computing environment and includes acts for comparing data items. The method includes accessing a query or command to retrieve data (act 502). The query or command includes an identification of a data item, a logical operator and a specialized token. For example, the identification of a data item may be by identification of an item in a data store, or by simply identifying some value. The specialized token may be a token including the features of the AntiNull described above. The logical operator may be one of the operators shown in FIG. 1.

The method 500 further includes performing a comparison as defined by the logical operator between the data item and the specialized token (act 504). The logical operator comparison and result is as shown in FIG. 1. In particular, for an equal logical operation any data item compared to specialized token is true; for a greater than logical operation on any item compared to the specialized token is true; for a less than logical operation on any item compared to the specialized token is true; for a greater than or equal to logical operation on any item compared to the specialized token is true; for a less than or equal to logical operation on any item compared to the specialized token is true; for a not equal logical operation on any item compared to the specialized token is false; for an IN logical operation on any set of items compared to specialized token is true; and for a NOT IN logical operation on any set of items compared to specialized token is false. As a result of the comparison, the method 500 includes retrieving or not-retrieving the data item (act 506). In particular, the logical result may cause a data item to be retrieved. Alternatively, the logical result may be such that the data item is not retrieved.

The method 500 may be practiced where the query or command further includes a mathematical operator that operates on the specialized token and one or more other data values. The result of the mathematical operator operating on the specialized token and the one or more other data values is the specialized token.

The method 500 may be practiced where the query or command further includes a string operator that operates on the specialized token and one or more other data values. The result of the string operator operating on the specialized token and the one or more other data values is the specialized token.

The method 500 may be practiced where the query or command further includes an aggregate function which operates over the specialized token. The result of the aggregate function operating over the specialized token is the specialized token.

The method 500 may be practiced where retrieving the data items as a result of the comparison comprises creating a query compliant with an underlying data store. In particular, the underlying data store may not support the specialized token. However, the created query is semantically equivalent to a query including the specialized token. This may be accomplished, for example, by following the process illustrated in FIG. 4.

The method 500 may further include configuring a standard value in a user interface to be represented by the specialized token. For example, as shown in FIG. 3B, the “All Categories” selection may be a standard value that could be represented by the specialized token.

The method 500 may further include receiving user input selecting an option representative of all categories of a data item, and converting that selection to the specialized token. For example, as shown in FIG. 3C, the “(Select All)” selection may be associated with the specialized token.

The method 500 may further include binding a user interface option that selects all user interface options from a set of user interface options to the specialized token.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware and software, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment comprising one or more processors, a method of comparing data items, the method comprising one or more of the one or more processors performing the following:
accessing a query or command to retrieve data, the query or command comprising an identification of a data item, a logical operator and a specialized token;
performing a comparison as defined by the logical operator between the data item and the specialized token, wherein the logical operator comparison and result is as follows:
for an equal logical operation any data item compared to specialized token is true;
for a greater than logical operation on any item compared to the specialized token is true;
for a less than logical operation on any item compared to the specialized token is true;
for a greater than or equal to logical operation on any item compared to the specialized token is true;
for a less than or equal to logical operation on any item compared to the specialized token is true;
for a not equal logical operation on any item compared to the specialized token is false;
for an IN logical operation on any set of items compared to specialized token is true; and
for a NOT IN logical operation on any set of items compared to specialized token is false; and
retrieving or not-retrieving the data item as a result of the comparison.

2. The method of claim 1, wherein retrieving the data items as a result of the comparison comprises creating a query compliant with an underlying data store, wherein the underlying data store does not support the specialized token, but where the created query is semantically equivalent to a query including the specialized token.

3. The method of claim 1, further comprising receiving user input selecting an option representative of all categories of a data item, and converting that selection to the specialized token.

4. The method of claim 1, wherein the query or command further comprises a mathematical operator that operates on the specialized token and one or more other data values and wherein the result of the mathematical operator operating on the specialized token and the one or more other data values is the specialized token.

5. The method of claim 1, wherein the query or command further comprises a string operator that operates on the specialized token and one or more other data values and wherein the result of the string operator operating on the specialized token and the one or more other data values is the specialized token.

6. The method of claim 1, wherein the query or command further comprises an aggregate function which operates over the specialized token and wherein the result of the aggregate function operating over the specialized token is the specialized token.

7. The method of claim 1 further comprising configuring a standard value in a user interface to be represented by the specialized token.

8. The method of claim 1, further comprising binding a user interface option that selects all user interface options from a set of user interface options to the specialized token.

9. In a computing environment, a system for comparing data items, the system comprising:
a data store storing data items;
a user interface, coupled to the data store, wherein the user interface comprises functionality to allow a user to select categories of data items for retrieval from the data store;
a module implemented by one or more processors executing computer readable instructions stored on one or more physical computer readable media, wherein the module is configured to perform a comparison as defined by a logical operator between data items and a specialized token, wherein the operator comparison and result is as follows:
for equal operation any data item compared to specialized token is true;
for a greater than operation on any item compared to the specialized token is true;
for a less than operation on any item compared to the specialized token is true;
for a greater than or equal to operation on any item compared to the specialized token is true;
for a less than or equal to operation on any item compared to the specialized token is true;
for a not equal operation on any item compared to the specialized token is false;
for an IN operation on any set of items compared to specialized token is true; and
for a NOT IN operation on any set of items compared to specialized token is false; and
a module configured to retrieve or not-retrieve data items from the data store as a result of the comparison.

10. The system of claim 9, a translation module configured to create a query compliant with the data store, wherein the data store does not support the specialized token, but where the created query is semantically equivalent to a query including the specialized token.

11. The system of claim 9, further comprising a module configured to receive user input at the user interface selecting an option representative of all categories of a data item, and convert that selection to the specialized token.

12. The system of claim 9, further comprising a module configured to perform operations according to mathematical operators that operate on the specialized token and one or more other data values and wherein the result of the mathematical operators operating on the specialized token and the one or more other data values is the specialized token.

13. The system of claim 9, further comprising a module configured to perform operations according to string operators that operates on the specialized token and one or more other data values and wherein the result of the string operators operating on the specialized token and the one or more other data values is the specialized token.

14. The system of claim 9, further comprising a module configured to perform operations according to aggregate functions which operate over the specialized token and wherein the result of the aggregate functions operating over the specialized token is the specialized token.

15. The system of claim 9, wherein the user interface is configured to represent a standard value by the specialized token.

16. The system of claim 9, wherein the user interface is configured to bind a user interface option that selects all user interface options from a set of user interface options to the specialized token.

17. In a computing environment, a system for comparing data items, the system comprising:
one or more processors;
one or more computer readable media coupled to the one or more processors, the one or more computer readable media storing instructions that when executed by one or more of the processors implement one or more modules;
a module configured to perform a comparison as defined by a logical operator between data items and a specialized token, wherein the operator comparison and result is as follows:
for equal operation any data item compared to specialized token is true;
for a greater than operation on any item compared to the specialized token is true;
for a less than operation on any item compared to the specialized token is true;
for a greater than or equal to operation on any item compared to the specialized token is true;
for a less than or equal to operation on any item compared to the specialized token is true;
for a not equal operation on any item compared to the specialized token is false;
for an IN operation on any set of items compared to specialized token is true; and
for a NOT IN operation on any set of items compared to specialized token is false;
a module configured to perform operations according to mathematical operators that operate on the specialized token and one or more other data values and wherein the result of the mathematical operators operating on the specialized token and the one or more other data values is the specialized token;
a module configured to perform operations according to string operators that operates on the specialized token and one or more other data values and wherein the result of the string operators operating on the specialized token and the one or more other data values is the specialized token;
a module configured to perform operations according to aggregate functions which operate over the specialized token and wherein the result of the aggregate functions operating over the specialized token is the specialized token;

18. The system of claim 17, further comprising a module configured to receive user input at a user interface selecting an option representative of all categories of a data item, and convert that selection to the specialized token.

19. The system of claim 17, further comprising a translation module configured to create a query compliant with the data store, wherein the data store does not support the specialized token, but where the created query is semantically equivalent to a query including the specialized token.

20. The system of claim 17, further comprising a module configured to bind a user interface option that selects all user interface options from a set of user interface options to the specialized token.
